(19) United States
(12) Patent Application Publication
(10) Pub. No.: US 2019/0118340 A1
(43) Pub. Date: Apr. 25, 2019

(54) IMPELLER FOR ACCELERATING ABRASIVE IN CENTRIFUGAL ACCELERATOR OF BLASTING APPARATUS, METHOD FOR MANUFACTURING THE IMPELLER AND THE BLASTING APPARATUS EQUIPPED THE IMPELLER THEREWITH

(71) Applicant: Fuji Manufacturing Co., Ltd, Tokyo (JP)

(72) Inventor: Keiji MASE, Tokyo (JP)

(21) Appl. No.: 15/958,097

(22) Filed: Apr. 20, 2018

(30) Foreign Application Priority Data
Apr. 21, 2017 (JP) 2017-084527

(51) Int. Cl. B24C 5/06; B33Y 80/00

(52) U.S. Cl. CPC B24C 5/062; B33Y 80/00

(57) ABSTRACT

To provide an impeller for use in a blasting apparatus and being capable of more efficiently accelerating abrasives.

An impeller 30 has an external shape of a circular disk shape with a predetermined thickness, and has an abrasive entry port 31. Plural abrasive flow channels 32 are formed at predetermined spacings around the circumferential direction of the impeller 30 so as to pass through within the thickness. Each of the abrasive flow channels 32 has an inlet 32a communicated with the abrasive entry port 31 and an outlet 32b opening onto an outer peripheral face. These abrasive flow channels 32 are provided so as to be greatly inclined with respect to a radial direction of the impeller 30 such that an end on the outlet 32b side of the abrasive flow channel faces rearward in a rotation direction of the impeller. This greatly reduces the rotation resistance, and efficiently accelerates the abrasive and compresses air inside the abrasive flow channels 32, thereby accelerating the abrasive by both centrifugal force and ejection of compressed air.

### TECHNICAL FIELD

The present invention relates to an impeller for accelerating abrasives in a blasting apparatus, a blasting apparatus equipped with the impeller as an abrasive accelerator unit, and a method for manufacturing the impeller.

### BACKGROUND OF THE INVENTION

In a blasting apparatus for cutting and polishing a workpiece by ejecting abrasives such as abrasive grains toward the workpiece, an abrasive accelerator is provided to eject the abrasive toward the workpiece.

Such abrasive accelerators include air accelerators that accelerate by ejecting abrasives together with compressed air using nozzles, centrifugal accelerators that accelerate abrasives by using a rotating impeller to impart centrifugal force thereto, and strike-style accelerators that accelerate by causing shot to collide with rotating blades, and the like.

From among the above, an example of such a centrifugal accelerator is illustrated in FIG. 9. This centrifugal accelerator is provided with an impeller 130 configured by a circular disk to which plural blades 135 are attached. The impeller 130 includes a body 133 configured from a metal circular disk, an opposing plate 134 formed in an endless ring shape with an opening at the center thereof to serve as an abrasive entry port 131, and plural blades 135 that span between the body 133 and the opposing plate 134. Abrasive flow channels 132 are each formed between one of the blades 135 and another of the blades 135, and the abrasive moves from the inner peripheral side to the outer peripheral side of the abrasive flow channels 132.

As illustrated in FIG. 6 and FIG. 7, the impeller 130 formed in this manner is rotated in a state in which the outer periphery of the impeller 130 except for a part thereof is covered by a casing 150′ and a belt 150. When the abrasives are introduced into the abrasive entry port 131, the abrasives introduced into each of the abrasive flow channels 132 through an inlet 132a at an end of the inner periphery end of the abrasive flow channel 132 are imparted with centrifugal force, and move inside the abrasive flow channel 132 toward the outer periphery of the abrasive flow channel 132. According to this configuration, the abrasives are ejected when the outer peripheral end (outlet 132b) of each of the abrasive flow channels 132 is opened from a state blocked off by the casing 150′ and the belt 150.

In the impeller 130 provided to a centrifugal accelerator of such a blasting apparatus, there are cases in which the blades 135 are disposed in a radial pattern along the radial direction of the impeller 130, as illustrated in FIG. 6 (see Patent Documents 1 and 2). Alternatively, in cases in which they are disposed inclined to the radial direction, a configuration is generally adopted in which the outer peripheral ends 135b of the blades 135 are disposed inclined to the radial direction so as to tilt rearward in the rotation direction. In such cases, the inclination with respect to the radial direction is at a comparatively small inclination angle, such that an angle of intersection between the impeller radius and the outer peripheral ends 135b of the blades 135 (an outlet angle) is about 5° as illustrated in FIG. 7 (see FIG. 2 of Patent Document 2).

Note that hitherto an ordinary rotor generally has a structure, as illustrated in FIG. 9, in which two circular disk plates configuring the body 133 and the opposing plate 134 are fixed together by a method such as bolt fastening, with the blades 135 interposed therebetween. However, as illustrated in Patent Document 3 referred to below, there are also proposals for an integrally-structured impeller 230 provided with an abrasive entry port 231 and abrasive flow channels 232 by mechanical cutting a circular disk integrally formed from a resin or the like.

In such an integrally-structured impeller 230, the abrasive flow channels 232 are formed within the thickness of the impeller 230 by direct cutting as illustrated in FIG. 8. This means that a configuration corresponding to the blades 135 in the impellers 130 illustrated in FIG. 6 and FIG. 7 is not provided. However, a configuration is adopted in which the abrasive flow channels 232 are formed with a straight line profile having a constant and unchanging diameter, such that outlets 232b of the abrasive flow channels 232 are slightly inclined with respect to the radial direction (with an outlet angle of from 12° to 22° in claim 2 of Patent Document 3), so as to face rearward in the rotation direction of the impeller 230.

### RELATED ARTS

### Patent Documents

Patent Document 1: Japanese Utility Model Application Laid-Open (JP-U) No. S63-11265

Patent Document 2: Japanese Patent Application Laid-Open (JP-A) No. 2005-206748

Patent Document 3: Japanese Patent No. 3927812

### SUMMARY OF THE INVENTION

### Problem to be Solved by the Invention

As described in the above examples of Patent Documents 1 to 3, in the impellers 130, 230 for abrasive acceleration that are provided in centrifugal accelerators of conventional blasting apparatuses, the blades 135 and the abrasive flow channels 232 are formed with simple straight line profiles. The blades 135 and the abrasive flow channels 232 are also disposed facing along the radial direction, or even in cases in which they are disposed inclined to the radial direction, inclined by a comparatively small amount.

The structure of such impellers 130, 230 is now established by persons of skill in the art for the structure of an impeller for use in a blasting apparatus, and is not one that considers the profile, placement, and the like of the blades 135 and the abrasive flow channels 232 of the impellers 130, 230.

However, if revisiting the structure of the impellers 130, 230 were to enable rotation imparted to the impellers 130, 230 to be more efficiently converted into an ejection speed of the abrasive, then this would enable the required ejection speed of the abrasive to be obtained by more compact impellers 130, 230 rotating at lower rotation speeds. This would enable a blasting apparatus to be more compact overall, the motor rotating the impellers 130, 230 to be smaller, and energy savings to be achieved.

Centrifugal accelerators for blasting apparatuses are, as the name suggests, devices to accelerate abrasives by imparting centrifugal force. The impellers 130, 230 provided in centrifugal accelerators are also designed exclusively from the perspective of imparting centrifugal force to the abrasive, and are not designed with consideration to compressing air inside the abrasive flow channels 132, 232, nor to the flow speed of air or the like.

However, in the impellers 130, 230 of the centrifugal accelerators, the centrifugal force due to rotating the impellers 130, 230 does not only act on the abrasive, but also acts on the air inside the abrasive flow channels 132, 232. This means that it should be possible to compress air inside the abrasive flow channels therewith. Adopting profiles and structures for the blades 135 and the abrasive flow channels 132, 232 to enable air inside flow channel widths to be efficiently compressed would result in compressed air being ejected together with the abrasive when the outlets 132b, 232b of the abrasive flow channels 132, 232 have been opened. This could be employed to accelerate the abrasives, and is thought to potentially enable greater and more efficient acceleration of the abrasives to be performed.

An object of the present invention is accordingly, for an impeller provided to a centrifugal accelerator of a blasting apparatus, to fundamentally redesign the profile and structure of blades and abrasive flow channels, which hitherto had not been considered, so as to enable rotation imparted to the impeller to be more efficiently converted into the ejection speed of abrasives. The object is moreover to provide an impeller for use in a blasting apparatus capable of accelerating abrasive using airflow by compressing air inside abrasive flow channels to a comparatively high pressure using centrifugal force so as to enable high speed ejection thereof, and to provide a blasting apparatus equipped with such an impeller.

### Means to Solve the Problems

Reference numerals are used in the following when describing embodiments to implement the present invention as a means to solve the problems. However, these reference numerals are merely employed to clarify correspondences between recitation in the scope of the patent claims and description of the embodiments to implement the present invention, and are obviously not employed to limit the interpretation of the technical scope of the invention of the present application.

In order to achieve the above objective of the invention, an impeller for use in a blasting apparatus is characterized by that:

the impeller 30 has an external shape of a circular disk shape with a predetermined thickness, and includes an abrasive entry port 31 at a center, for example, and a plurality of abrasive flow channels 32 formed at predetermined spacings around the circumferential direction within the thickness of the impeller 30, each of the abrasive flow channels 32 having an inlet 32a communicated with the abrasive entry port 31 and an outlet 32b opening onto an outer peripheral face of the impeller 30;

the abrasive flow channels 32 are provided so as to be inclined with respect to a radial direction of the impeller 30 such that ends on the outlet 32b side of the abrasive flow channels 32 face to a rearward side in a rotation direction of the impeller 30; and

an intersection angle (an inlet angle (β1) between ends at the inlet 32a side of inner walls at the rearward side in the rotation direction of the abrasive flow channels 32 (an inner peripheral ends 35a of the blades 35) and a radius of the impeller 30, and an intersection angle (an outlet angle β2) between ends at the outlet 32b side of the inner walls at the rearward side in the rotation direction of the abrasive flow channels 32 (an outer peripheral ends 35b of the blades 35) and the radius of the impeller 30 are both 30° or greater.

The impeller 30 further comprises a body 33 formed in a circular disk shape;

an opposing plate 34 formed in an endless ring shape (for example, a torus-shape), and opposed to the body 33 and the opposing plate 34 having substantially the same diameter with the body 30 and including the abrasive entry port 31 at the center thereof, and a plurality of blades 35 disposed at predetermined spacings along a circumferential direction so as to span between the body 33 and the opposing plate 34, each of the abrasive flow channels 32 being formed between one of the blades 35 and another of the blades 35; and

each of the blades 35 are formed with a curved profile such that a center portion in a longitudinal direction of each of the blades 35 bulges forward in the rotation direction.

The abrasive flow channels 32 are formed with a profile in which a width of the abrasive flow channels 32 (see FIG. 4) in the thickness direction of the impeller 30 gradually narrows from the inlet 32a side toward the outlet 32b side.

Preferably, a wear resistant protection member is attached to an inner wall at the rearward side in the rotation direction of the abrasive flow channels 32 (the convex faces of the blades 35).

A blasting apparatus 1 according to the present invention includes:

the impeller 30 according to any of the above described configurations as an abrasive accelerator unit;

a drive source such as a motor (not illustrated in the drawings) to rotate the impeller 30;

an abrasive feed unit 40 to feed the abrasives into the abrasive entry port 31 of the impeller 30; and

a covering unit 50 such as a belt covering an outer periphery of the impeller 30 except for a portion thereof.

The impeller 30 configured as described above may be manufactured using additive manufacturing by a 3D printer.

### Effect of the Invention

According to a configuration of the present invention as explained above, a blasting apparatus 1 equipped with an impeller 30 of the present invention as an abrasive accelerator unit is able to obtain the following significant advantageous effects.

A configuration is adopted in which the abrasive flow channels 32 provided to the impeller 30 are formed so as to be inclined with respect to the radial direction of the impeller 30 such that ends on the outlet 32b side (outer peripheral side) of the abrasive flow channels 32 face rearward in the rotation direction of the impeller 30, and the abrasive flow channels 32 are inclined so as to be disposed at a comparatively large angle (disposed in a reclined state), such that an inlet angle β1 and an outlet angle β2 are both 30° or greater. This enables resistance when rotated to be reduced and efficiently accelerates the abrasives and compresses air, enabling the abrasives to be accelerated by the synergistic effects of both centrifugal force and compressed air.

Moreover, the blades 35 partitioning the abrasive flow channels 32 have curved profiles such that the longitudinal direction centers thereof bulge forward in the rotation direction. This enables the outlet angle β2 to be made greater than cases in which the blades provided have straight line shapes for the same angle of the inlet angle β1. The further reduction in resistance when rotated enables acceleration of the abrasives and compression of air to be performed even more efficiently.

Moreover, the abrasive flow channels 32 (the blades 35) are given a large inclination as described above, and the blades 35 have curved profiles. This means that in the structure of the impeller 30 of the present invention, the air inside the abrasive flow channels 32 can be compressed to a higher pressure than cases in which the abrasive flow channels 32 (the blades 35) are only given a slight inclination, and cases in which the blades 35 are formed with straight line profiles. The compressed air discharged from the abrasive flow channels 32 that has been compressed in this manner can be favorably utilized to accelerate the abrasive.

Moreover, in a configuration in which the abrasive flow channels 32 are formed with a profile having a width in the thickness direction of the impeller 30 that gradually narrows on progression from the inlet 32a side toward the outlet 32b side (see FIG. 4), the airflow in the abrasive flow channels 32 from the inlets 32a toward the outlets 32b has increased flow speed and flows out from the outlets 32b at a higher pressure than at the abrasive entry port 31 due to the centrifugal force from rotating the impeller. This enables the accelerating action on the abrasives to be further improved by the airflow generated inside the abrasive flow channels 32 with rotation of the impeller 30.

Moreover, in the impeller 30 configured with the wear resistant protection members 36 attached to the inner walls (the convex faces of the blades 35) at the rear in the rotation direction of the abrasive flow channels 32, wear arising from contact with the abrasives can be prevented. This enables the lifespan of the impeller 30 to be prolonged, and, when wear has occurred, enables the impeller 30 to be refurbished by replacing the protection members 36 alone, thereby running costs can be suppressed.

Moreover, preventing wear by using the protection members 36 enables the body portion of the impeller 30 to be manufactured, for example, from a resin or the like. This enables energy savings accompanying the reduced weight of the impeller 30 to be achieved.

Moreover, manufacturing the impeller by additive manufacturing using a 3D printer enables integral manufacture even when the impeller has a complex profile. This enable the strength of the impeller to be raised further.

### BRIEF DESCRIPTION OF DRAWINGS

FIG. 1 is an explanatory diagram of a blasting apparatus of the present invention.

FIG. 2 is an explanatory diagram of a blasting apparatus of the present invention, and illustrates a modified example of an abrasive feed unit.

FIG. 3 is a face-on view of impellers for use in a blasting apparatus of the present invention.

FIG. 4 is a cross-section taken on line IV-IV of FIG. 3.

FIG. 5 is an enlarged cross-section taken on line V-V of FIG. 3.

FIG. 6 is an explanatory diagram of a conventional impeller for use in a blasting apparatus (corresponding to Patent Document 1).

FIG. 7 is an explanatory diagram of a conventional impeller for use in a blasting apparatus (corresponding to Patent Document 2).

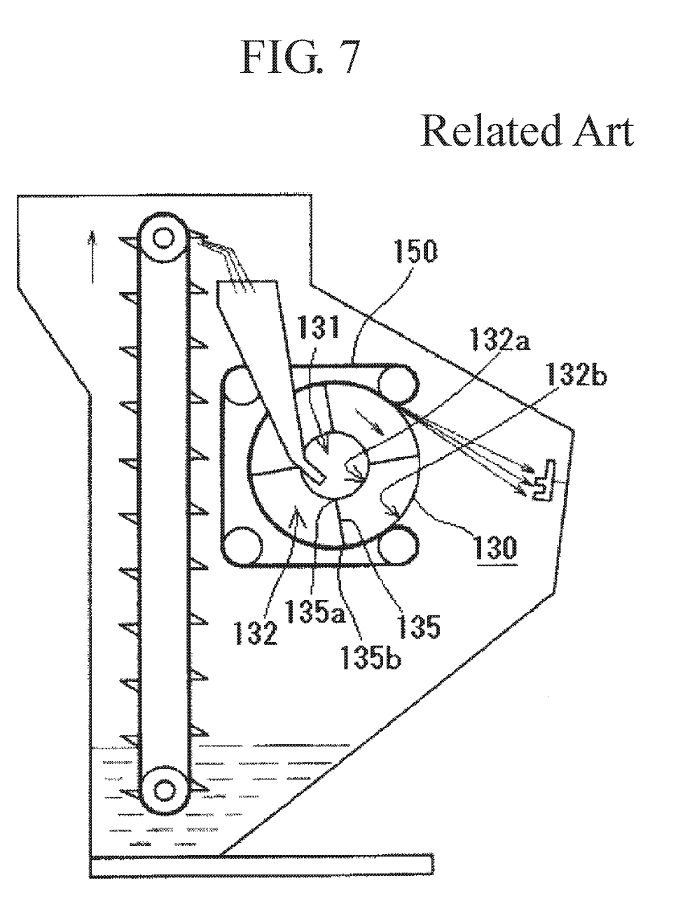

FIG. 8 is an explanatory diagram of a conventional impeller for use in a blasting apparatus (corresponding to Patent Document 3).

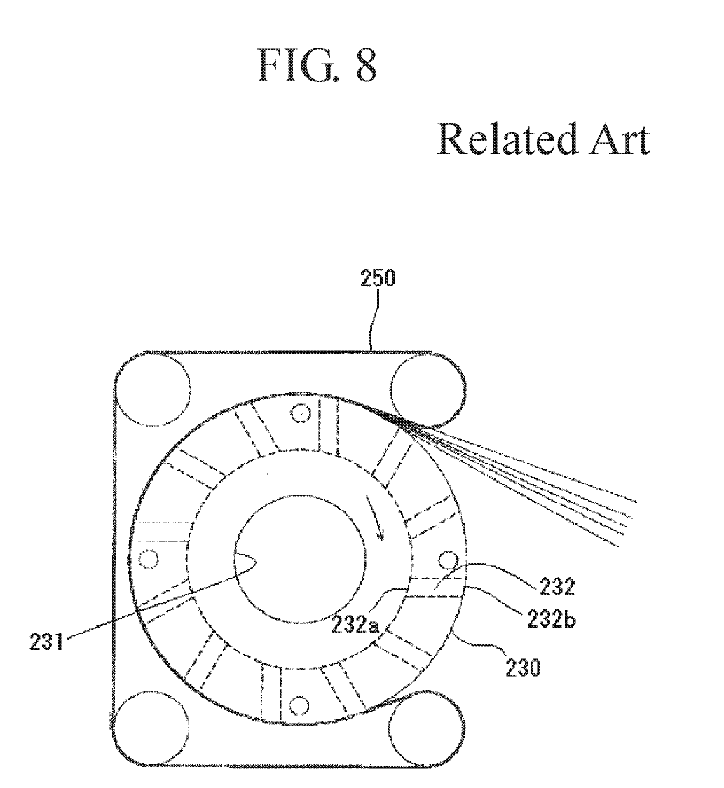

FIG. 9 is an exploded perspective view of a conventional impeller for use in a blasting apparatus.

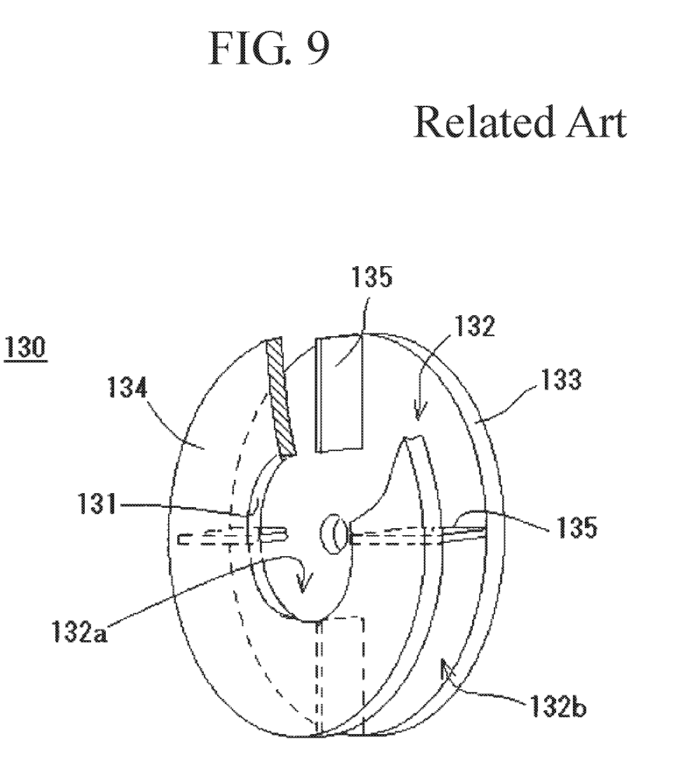

### DESCRIPTION OF EMBODIMENTS

Explanation follows regarding embodiments of the present invention, with reference to the appended drawings.

### Overall Structure of Blasting Apparatus

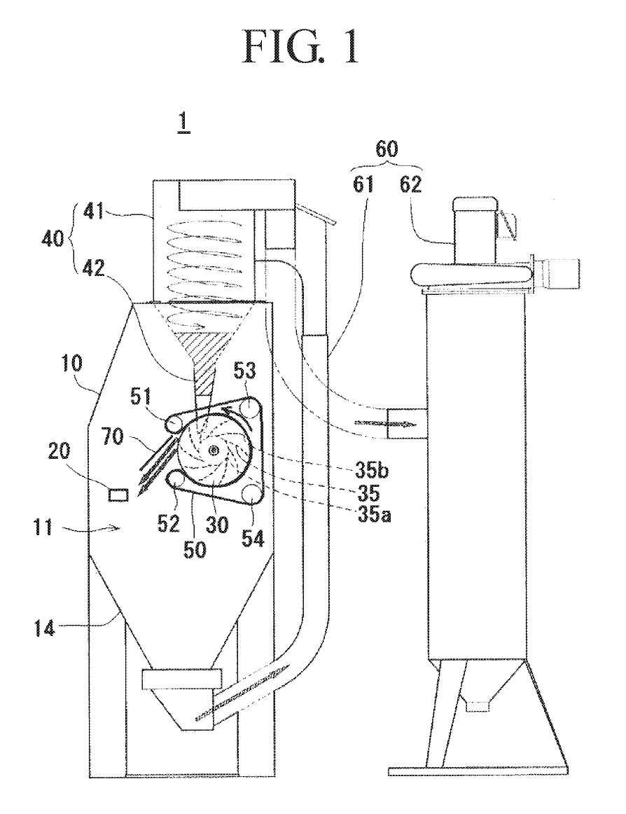

FIG. 1 illustrates an overall configuration of the blasting apparatus 1 of the present invention.

The blasting apparatus 1 is configured so as to eject abrasives onto a workpiece 20 inside a processing chamber 11 formed inside a cabinet 10, so as to prevent pollution to the working environment from flying abrasives, cutting dust, and the like. An openable/closeable loading door (not illustrated in the drawings) is accordingly provided in a side wall of the cabinet 10 for loading the workpiece 20 inside the processing chamber 11 and unloading therefrom.

An impeller 30 serving as an abrasive accelerator unit, an abrasive feed unit 40 to feed abrasive into the impeller, and a covering unit 50 covering the outer periphery of the impeller 30 except for a portion thereof are provided inside the processing chamber 11. This achieves a configuration in which rotating the impeller 30 using a drive source, such as a non-illustrated motor or the like, enables the abrasive to be ejected toward the workpiece 20 by the centrifugal force due to rotation of the impeller 30.

### Impeller

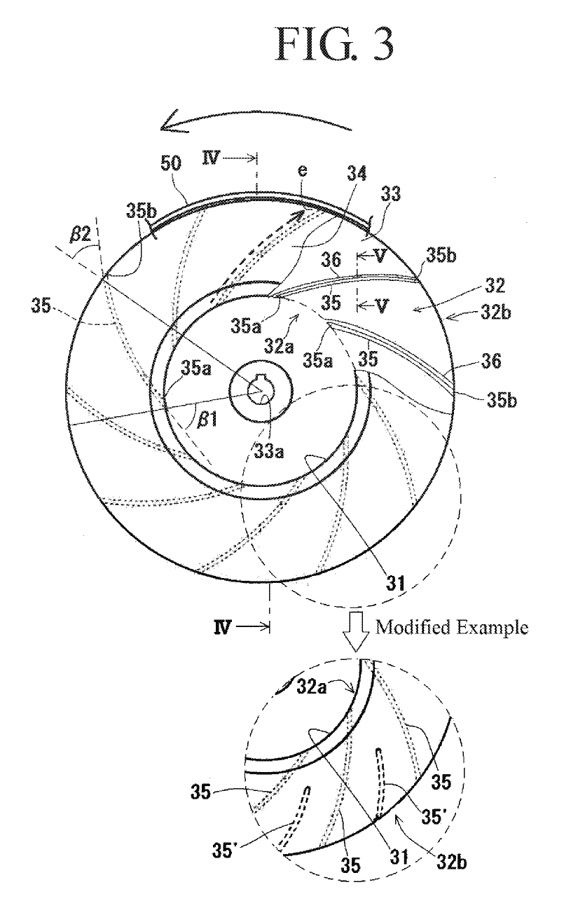

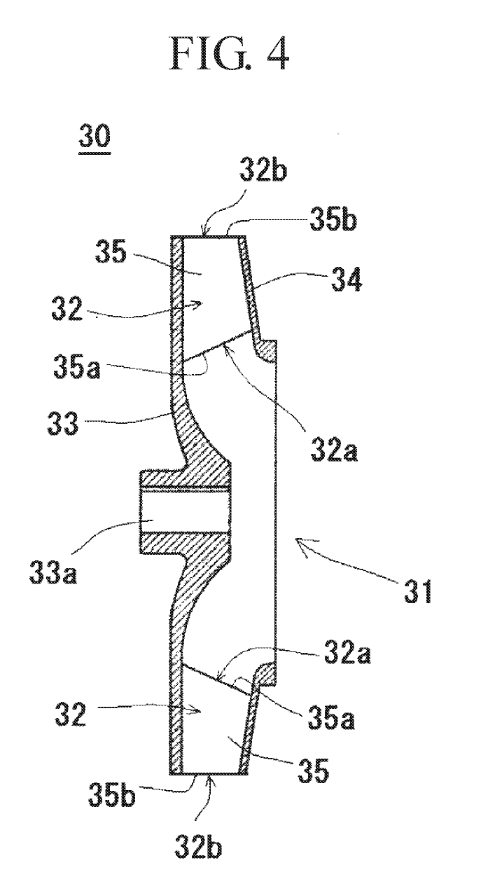

As illustrated in FIG. 3 and FIG. 4, the impeller 30 serving as the abrasive accelerator unit has an external shape of a circular disk shape having a predetermined thickness. An abrasive entry port 31 is formed in a central portion of the impeller 30, and plural abrasive flow channels 32 are formed within the thickness of the impeller 30 at predetermined spacings along the circumferential direction. Each of the abrasive flow channels 32 includes an inlet 32a communicated with the abrasive entry port 31 and an outlet 32b opening in the outer peripheral face of the impeller 30.

In the illustrated embodiment, the impeller 30 is configured by a substantially circular disk shaped body 33, an opposing plate 34, and plural blades 35. The body 33 includes a boss and is formed with an axial hole 33a at the center to insert a support shaft through. The opposing plate 34 is substantially the same diameter as the body 33 and the abrasive entry port 31 is formed through the center thereof. The blades 35 span between the body 33 and the opposing plate 34. The abrasive flow channels 32 are each formed between one of the blades 35 and another of the blades 35.

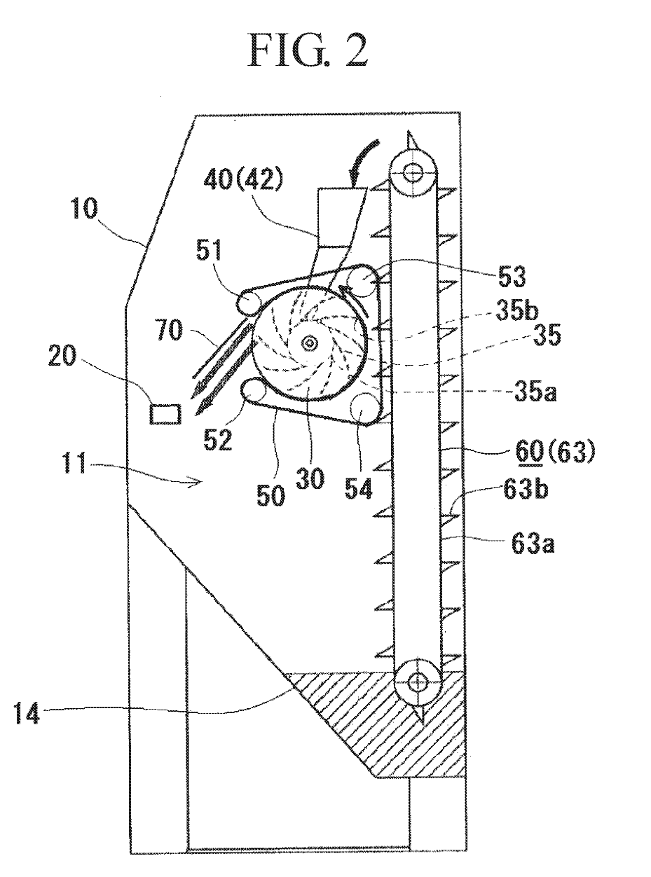

The blades 35 partitioning the abrasive flow channels 32 are formed in the illustrated embodiment with plates shapes of constant thickness. As illustrated in FIG. 1 and FIG. 2, the blades 35 are provided such that outer peripheral ends 35b of the blades 35 are inclined so as to face rearward in the rotation direction of the impeller 30. Due to the blades 35 being disposed in this manner, the outlets 32b of the abrasive flow channels 32 that are each formed between one of the blades 35 and another of the blades 35 are similarly formed so as to open rearward in the rotation direction of the impeller 30.

The abrasive flow channels 32 are preferably inclined such that an inlet angle β1, which is the angle of intersection between inner peripheral ends of the inner walls at the rear in the rotation direction of the abrasive flow channels 32 (inner peripheral ends 35a of the blades 35) and the radius of the impeller 30, and an outlet angle β2, which is an angle of intersection between outer peripheral ends of the inner walls at the rear in the rotation direction of the abrasive flow channels 32 (the outer peripheral ends 35b of the blades 35) and the radius of the impeller 30, are each 30° or greater.

The blades 35 partitioning the abrasive flow channels 32 are preferably formed with a curved profile such that a longitudinal direction center of the blades 35 bulges forward in the rotation direction.

Forming in this manner enables a configuration to be achieved (i.e. a reclined state of the blades 35) in which the outlet angle β2 of the blades 35 is a larger angle than cases in which blades 35 with a straight line profile are provided, for the same inlet angle β1.

In the illustrated embodiment, the blades 35 are formed with a curved profile so as to form the inlet angle β1 and the outlet angle β2 such that the inlet angle β1 of the abrasive flow channels is about 60° and the outlet angle β2 of the abrasive flow channels is about 45°.

There are preferably from 10 to 40 of the blades 35 provided at a constant spacing around the circumferential direction. More preferably, the number of the blades 35 is adjusted such that the width of the outlets 32b of the abrasive flow channels 32 is in a range of from 10 mm to 80 mm.

In one embodiment, the impeller 30 has a diameter of 200 mm and is provided with 20 of the blades 35 so as to form the abrasive flow channels 32 with a 30 mm width of the outlets 32b.

Note that FIG. 3 illustrates an example having half the number of the blades 35 to in the above example, i.e. 10 blades, provided to the impeller 30 of the same 200 mm diameter thereto, and having the abrasive flow channels 32 formed such that the width of the outlets 32b is 60 mm.

Moreover, auxiliary blades 35′ shorter than the blades 35 may be provided between adjacent pairs of the blades 35, so as to divide the outlet 32b side (see the modified example in FIG. 3).

The illustrated example shows a configuration in which one of the auxiliary blades 35′ is provided for each of the abrasive flow channels 32, and the outlet 32b side of the abrasive flow channels 32 is divided into two. However, plural auxiliary blades 35′ may be provided for each of the abrasive flow channels 32.

In this manner, the abrasive flow channels 32 that are each formed between one of the blades 35 and another of the blades 35 have a profile in which the width of the abrasive flow channel 32 gradually widens on progression from the inlet 32a side toward the outlet 32b side, as illustrated in the face-on view of FIG. 3. This means that for cases in which the width of the abrasive flow channels 32 is constant in the thickness direction of the impeller 30, the flow channel sectional area widens on progression toward the outer peripheral side of the abrasive flow channels 32, from the inlet 32a side toward the outlet 32b side thereof.

For an airflow flowing inside a tube, there is a decrease in flow speed when the flow channel sectional area increases. Thus, when the abrasive flow channels 32 have profiles in which the flow channel sectional area widens from the inner peripheral side toward the outer peripheral side, the flow speed of the airflow flowing inside the abrasive flow channels 32 is decreased on progression toward the outlet 32b side.

As illustrated in FIG. 4, the impeller 30 of the present invention is configured with the abrasive flow channels 32 formed in a tapered profile such that a width thereof in the thickness direction of the impeller 30 gradually narrow on progression from the inlet 32a side toward the outlet 32b side. This means that the flow channel sectional area of the abrasive flow channels 32 does not excessively widen on progression from the inlet 32a side toward the outlet 32b side, irrespective of the fact that the abrasive flow channels 32 have a profile viewed face-on, as in FIG. 3 in which the width widens from the inlet 32a side toward the outlet 32b side. Adjustment is made such that, depending on the case, the flow channel sectional area is either constant or decreases on progression from the inlet 32a side toward the outlet 32b side. This thereby maintains the flow speed at the vicinity of the outlet 32b of the airflow flowing inside each of the abrasive flow channels 32 when the outlet 32b of the abrasive flow channels 32 has been opened, or, depending on the case, increases the flow speed. This enables the ejection speed of the abrasive to be raised by the airflow.

Note that the profile in the example illustrated in FIG. 4 is formed such that, from out of the body 33 and the opposing plate 34, it is the opposing plate 34 side that is sloped so as to approach the body side on progression from the inner peripheral side toward the outer peripheral side. However, a decrease in flow channel width may be achieved by forming the profile such that the body 33 side slopes, or both the body 33 side and the opposing plate 34 side slope.

Note that the illustrated embodiment is configured such that around the axial hole 33a of the body 33, a truncated conical shape that bulges toward the abrasive entry port 31 side is provided to the opposing plate 34, enabling the flows of both the abrasive and air introduced through the abrasive entry port 31 to be smoothly converted into flows toward the inlets 32a of the abrasive flow channels 32.

The abrasive is introduced into the abrasive entry port 31 while the impeller 30 configured as described above is being rotated. The introduced abrasive is thereby imparted with a centrifugal force and relatively moves from the inner peripheral side toward the outer peripheral side along the inner walls (convex walls of the blades 35) at the rear of each of the abrasive flow channels 32 in the rotation direction. These portions (convex walls of the blades 35) are accordingly commensurably more liable to be worn by contact with the abrasive.

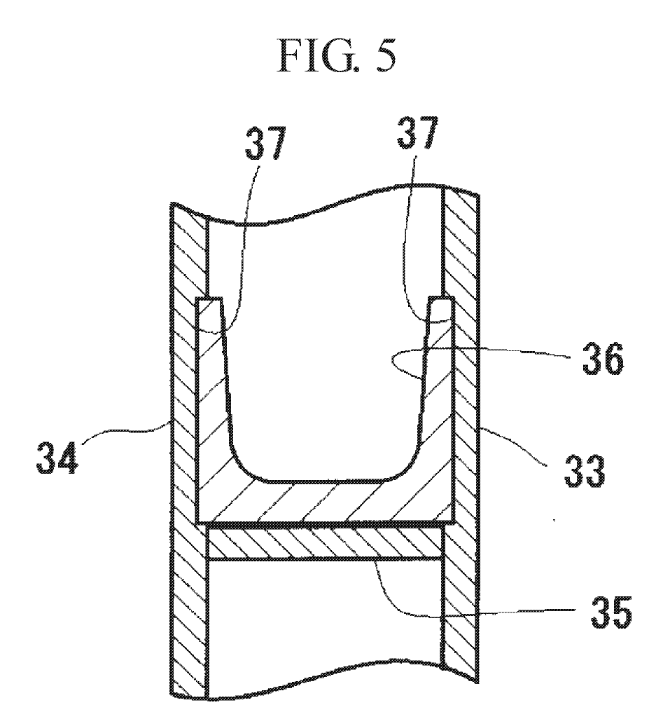

Thus, in the impeller 30 of the present invention, wear resistant protection members 36 are detachably mounted to these portions (the convex walls of the blades 35), as illustrated in FIG. 3 and FIG. 5. This thereby prevents wear of the blades 35 and enables simple refurbishment of the impeller 30 by replacing the protection members 36 when wearing has occurred. A reduction in the running cost can accordingly be achieved in comparison to cases in which the entire impeller 30 is replaced. A reduction in power consumption to rotate the impeller is also achieved due to being able to reduce the weight of portions other than the protection member 36 by, for example, using a resin therefor.

In the present embodiment, the protection members 36 are configured by channel-shaped members having a square C-shaped cross-section profile as illustrated in FIG. 5. This not only protects the blades 35 from wear, but also protects the inner wall faces of the body 33 and the opposing plate 34 in the vicinity of their boundaries with the blades 35 from wear due to contact with the abrasive.

Various materials can be employed for the protection members 36, as long as they are wear resistance. Examples of materials that may be employed therefor include ceramics (alumina, zirconia, silicon carbide, and the like), metals (iron-carbon alloys, manganese steels, titanium alloys, aluminum alloys, and the like), and resins (Delrin, ultrahigh molecular weight ethylene, and the like).

There is no particular limitation to the way in which the protection members 36 is attached, as long as it prevents the protection members 36 from flying off under the centrifugal force from rotating the impeller 30, and various attachment methods may be employed therefor. However, the protection members 36 are preferably attached in such a manner as to allow easy detachment.

In the illustrated embodiment, recesses 37 are respectively provided in the inner walls of the body 33 and the opposing plate 34 at the portions thereof where the protection members 36 are to be attached. This prevents the protection members 36 from flying off by fixing the outer peripheral ends of the protection members when the protection members 36 have been inserted into the respective recesses 37. However, the protection members 36 may be fixed by any of various known methods, such as by bonding with adhesive, bolt fastening, or the like, as long as the protection members 36 are prevented from flying off.

The impeller 30 of the present invention configured as described above may be manufactured by, for example, separately manufacturing the body 33, and each of the opposing plate 34, the blades 35, and the protection members 36, and then assembling these together using an adhesive, fastening, or the like. However, in order to obtain a stronger impeller 30, the body 33, the opposing plate 34, and the blades 35 are preferably manufactured as a single integrated structure.

Examples of methods to integrally manufacture the impeller 30 in this manner include employing known 3D printer technology including additive manufacturing such as stereolithography, powder methods, fused deposition modeling (FDM), sheet lamination methods, and ink jet methods. Employing the above methods enables easy integral forming in resin, metal, or a composite thereof, even for the impeller according to the present invention that is difficult to manufacture by machining or the like to cut the blades 35 and the abrasive flow channels 32 having curved profiles.

For example, stereolithography is technology to shape by curing a liquid photocurable resin by irradiating with an ultraviolet laser. In such stereolithography, a shape is modeled that corresponds to a 3D shape input to a computer using 3D-CAD. This enables a 3D object to be produced with high accuracy, without employing a cutter or the like. Moreover, comparatively easy integral modelling is possible even for the impeller 30 equipped with the curved profile blades 35 as illustrated in FIG. 3.

Examples of the photocurable resin include photopolymerizable oligomers (broadly defined as polymerization main agents and including monomers), reactive diluents, and photopolymerization initiators, with a photopolymerization accelerator, additive, and/or colorant blended therein as required.

The type of ultraviolet-curable resin employed in stereolithography depends on the type of photopolymerizable oligomer (broadly defined as polymerization main agents and including monomers), and includes urethane acrylate-based, epoxy-based, epoxy acrylate-based, and acrylate-based ultraviolet-curable resins and the like. Any of these may be employed to manufacture the impeller 30 of the present invention, and a urethane acrylate-based or epoxy-based resin is preferably employed therefor.

Moreover, a thermoplastic resin can be employed when manufacturing is performed with a powder method, fused deposition modeling (FDM), sheet lamination method, ink jet method, or the like. In such cases various thermoplastic engineering plastics can also be employed, such as ABS resins, polycarbonate resins, PC/ABS alloys and PPSF/PPSU resins, and ULTEM resins (polyetherimide: PEI).

Moreover, in such a powder method, the impeller can be manufactured from metal by sintering a metal powder using an electron beam, laser, electric arc discharge, or the like as a heat source. Examples of such metal materials include iron-based alloys (Fe—Cr—Ni—Mo, Fe—Cr—Ni—Cu, Fe—Ni—Mo—Co—Al—Ti), nickel-based alloys (Ni—Cr—Fe—Mo—Co—W, Ni—Cr—Mo—Nb), chromium-based alloys (Co—Cr—Mo), titanium-based alloys, aluminum-based alloys, copper-based alloys, and the like.

The surface of the impeller 30 is preferably finished smooth so as to reduce resistance to flows of abrasive and air. In particular, the surfaces of impellers modeled by 3D printers tend to be rough. For example, the surface of an impeller manufactured by sintering an SUS powder, has a surface roughness of an arithmetic mean roughness Ra (JIS B 0601-1994) from 5 μm to 10 μm. An energy loss accordingly occurs when transporting and ejecting the abrasive and air due to such roughness.

Therefore, the surface of the impeller 30 is preferably adjusted to a predetermined surface roughness. In the present embodiment, the surface roughness of the impeller 30 is polished to an arithmetic mean roughness Ra of 2.0 μm or less, and preferably of 1.0 μm or less.

Such polishing of the impeller 30 may be performed by using an elastic abrasive formed by supporting abrasive grains with an elastic body, either by kneading abrasive grains into the elastic body or by adhering abrasive grains to the surface of the elastic body. The elastic abrasive is then ejected, preferably by ejecting at an angle, onto the surface of the impeller, so as to polish to the predetermined surface roughness by causing the elastic abrasive to slide over the impeller surface. For example, polishing to achieve the target surface roughness may be performed by changing the abrasive employed in a step-wise manner, so that the granule size of the supported abrasive grains gets smaller.

In the present embodiment, after rough polishing by ejecting an elastic abrasive supporting #220 grit silicon carbide-based grains (“Sirius” #220 manufactured by Fuji Manufacturing Co., Ltd.), a finishing polish is performed by ejecting an elastic abrasive supporting #3000 grit silicon carbide-based grains (“Sirius Z” #3000 manufactured by Fuji Manufacturing Co., Ltd.) so as to achieve a surface roughness of Ra 1.0 μm or less.

### Abrasive Feed Unit

The impeller 30 configured as described above is rotatably supported in a vertical orientation in the processing chamber 11 inside the cabinet 10, as illustrated in FIG. 1 and FIG. 2, by a support shaft (not illustrated in the drawings) being inserted through the axial hole 33a provided through the center of the body 33. The abrasive is ejected by introducing the abrasive into the abrasive entry port 31 provided in the center of the impeller 30 while rotating the impeller 30 disposed in this manner.

In the blasting apparatus 1 illustrated in FIG. 1, the abrasive feed unit 40 to introduce the abrasive into the abrasive entry port 31 of the impeller 30 is accordingly configured including an abrasive tank 41 provided at the top of the cabinet 10, and a chute 42 communicating between the bottom of the abrasive tank 41 and the abrasive entry port 31 of the impeller 30. Configuration is such that when the abrasive is loaded into the abrasive tank 41, the abrasive that falls from the abrasive tank 41 is guided by the chute 42 so that the abrasive is introduced into the abrasive entry port 31 of the impeller 30.

Note that a known configuration of a centrifugal accelerator (JIS B 6614 1989) may be adopted in which a distributer, control gauge, and the like are provided at the bottom end of the chute 42 inserted into the abrasive entry port 31.

The embodiment illustrated in FIG. 1 is configured with inverted cone shaped hopper 14 provided at the bottom of the cabinet 10, enabling the abrasive ejected toward the workpiece 20 inside the processing chamber 11 of the cabinet 10 to be collected inside the hopper 14, together with the dust and the like generated by the polishing, after the workpiece 20 has been polished.

The abrasive tank 41 is formed so as to function as a cyclone. The bottom end of the hopper 14 and an inlet to the abrasive tank 41 are communicated with each other through a duct 61. An exhaust outlet provided to the abrasive tank 41 is communicated with an exhaust fan 62 provided to a dust collector.

Due to the blasting apparatus 1 illustrated in FIG. 1 being configured in this manner, when the exhaust fan 62 is operated so as to exhaust air inside the abrasive tank 41, a negative pressure is induced inside of the abrasive tank 41, and the abrasive and dust collected inside the hopper 14 is introduced into the abrasive tank 41 through the duct 61. The abrasive and the dust are classified inside the abrasive tank 41, such that the abrasive is collected at the bottom of the abrasive tank 41, whereas the dust is exhausted through the exhaust outlet and can be collected by the dust collector provided to the exhaust fan 62.

Thus, in the configuration of the blasting apparatus 1 illustrated in FIG. 1, an abrasive transport unit 60 is configured by the duct 61 and the exhaust fan 62, to transport the abrasive accumulated at the bottom of the processing chamber 11 to the abrasive tank 41.

Note that the blasting apparatus 1 illustrated in FIG. 1 is configured so as to enable the abrasive that has already been ejected to be classified into abrasive and dust, thereby the abrasive alone is reintroduced into the impeller 30.

In contrast thereto, the blasting apparatus 1 illustrated in FIG. 2 is configured so that the abrasive that has already been ejected is not classified into dust etc. and abrasive, and instead both are introduced into the abrasive entry port 31 of the impeller 30. The blasting apparatus 1 is accordingly provided with a chute 42 having an opening at the top end, and having a bottom end communicated with the abrasive entry port 31 of the impeller 30, and with a bucket conveyor 63 to lift abrasive accumulated in the bottom of the processing chamber 11 and to load the abrasive into the opening at the top end of the chute 42.

Thus in the configuration of the blasting apparatus 1 illustrated in FIG. 2, the chute 42 serves as the abrasive feed unit 40 to introduce the abrasive into the abrasive entry port 31 of the impeller 30, and the bucket conveyor 63 serves as the abrasive transport unit 60 to transport the abrasive accumulated in the bottom of the processing chamber 11 to the abrasive feed unit 40.

The bucket conveyor 63 is configured with buckets 63b attached to a chain belt 63a at predetermined spacings, such that when the chain belt 63a is rotated, the buckets 63b scoop up the abrasive accumulated in the bottom of the processing chamber 11 so as to enable the abrasives to be loaded into the opening at the top end of the chute 42.

Note that the abrasive feed unit 40 provided in the blasting apparatus of the present invention is not limited to the configurations illustrated in FIG. 1 and FIG. 2, and various configurations may be adopted therefor as long as they are able to introduce the abrasives into the entry port of the impeller.

### Covering Unit

The outer periphery of the impeller 30 disposed inside the processing chamber 11 of the cabinet 10 is, apart from a portion thereof, covered by covering by the covering unit 50. Thereby, the abrasive is only ejected from the outlets 32b of the abrasive flow channels 32 when rotationally moved to a position not covered by the covering unit 50. A configuration is thereby achieved in which the abrasives facing in a predetermined direction are ejected over a predetermined range.

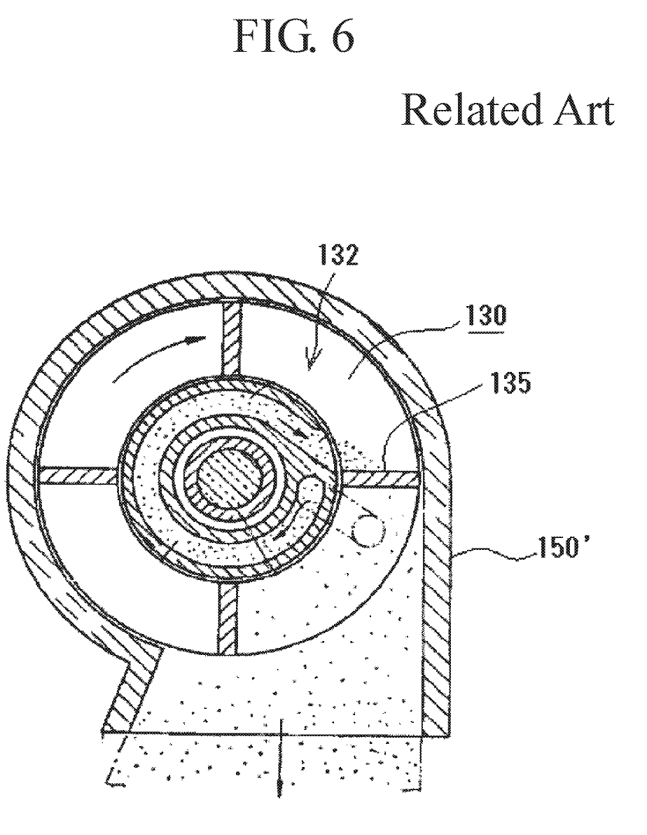

In the embodiment illustrated in FIG. 1 and FIG. 2, the covering unit 50 covering the outer periphery of the impeller 30 is a belt. However, the covering unit (belt) 50 to cover the outer periphery of the impeller 30 is not limited to such a belt and may, for example, be a casing or a cover that covers the impeller as in the conventional impeller described with reference to FIG. 6.

As illustrated in FIG. 1, in a configuration in which the belt 50 is wrapped around part of the outer periphery of the impeller 30 so that the outer periphery of the impeller 30 is covered, the belt 50 also serves the role of a motive force transmission unit to transmit rotational drive force to the impeller 30.

Therefore, in order to enable covering of the outer periphery of the impeller 30, and motive force transmission thereto, to be performed by the belt 50, in the illustrated embodiment, there are four pulleys 51 to 54 provided at the outer peripheral side of the impeller 30 so as to surround the impeller 30. The endless belt 50 is attached so as to be entrained around the outer periphery of the four pulleys 51 to 54. The belt 50 between the two pulleys 51, 52 disposed at the front side of the impeller 30 is pulled rearward so as to wrap around the outer periphery of the impeller 30.

One out of the pulleys 51 to 54 (for example the pulley 53) is a drive pulley connected to an output shaft of a non-illustrated motor, serving as a drive unit. In this configuration, rotating of the drive pulley 53 transmits the rotational drive force of the drive pulley 53 through the endless belt 50 to the following pulleys 51, 52, 54 and to the impeller 30.

Note that in the present embodiment, an example is described in which one of the pulleys 51 to 54 is connected to and rotated by a drive source, such as a motor. However, a configuration may be adopted in which a motor is directly connected to the impeller 30 to enable the impeller 30 to be rotated.

### Drive Unit

As described above, in the present embodiment, the drive source to rotate the impeller 30 is a motor (not illustrated in the drawings). Preferably, an inverter-controlled motor is provided as the drive source, so as to enable the rotation speed of the motor, and hence also the rotation speed of the impeller 30, to be controlled to a set predetermined target rotation speed.

### Other

Note that the abrasive shot out by rotation of the impeller 30 may be ejected directly onto the workpiece 20. However, the abrasive shot out by the impeller 30 may, for example, be guided by a guide plate 70 and ejected toward the workpiece 20, as illustrated in FIG. 1 and FIG. 2, so as to enable control of the ejection range of the abrasive.

The guide plate 70 may be formed with a square C-shape or U-shape opening that faces downward in a cross-section along the width direction, so as to be able to control the ejection range of the abrasive not only in the vertical direction, but also in the horizontal direction.

Moreover, air nozzles (not illustrated in the drawings) may be provided parallel to the guide plate 70. An airflow in the same direction as the movement direction of the abrasive is generated by ejecting compressed air from the air nozzles, so as to either suppress a decrease in the ejection speed of the abrasive, or to accelerate the ejection speed using the airflow.

Moreover, although omitted from the diagrams, the abrasive shot out by the impeller 30, or the abrasive shot out by the impeller and guided by the guide plate 70, may be introduced into a tube shaped guide tube, so that the abrasives are bombarded against the workpiece 20 after the flight direction of the abrasives have been changed.

In cases in which such a guide tube is provided, a configuration may be adopted in which compressed air is ejected from a nozzle provided at an inlet side of the guide tube and an airflow is generated inside the guide tube from the inlet side toward the outlet side, so as to enable the abrasive introduced into the guide tube to be further accelerated.

### Operation Etc

In the blasting apparatus 1 of the present invention configured as described above, while the impeller 30 is being rotated by a non-illustrated motor (rotated in a counterclockwise direction in the examples in FIG. 1 and FIG. 2), the abrasive is introduced into the abrasive entry port 31 of the impeller 30 through the chute 42. The abrasive that has entered into the abrasive flow channels 32 through the inlet 32a communicating with the abrasive entry port 31 is imparted with centrifugal force by the rotation of the impeller 30, and moves inside the abrasive flow channels 32 toward the outlet 32b side.

At the outer periphery of the impeller 30, the outlets 32b of the abrasive flow channels 32 except for a part thereof are blocked off by a covering member, i.e., the belt 50. When the outlets 32b blocked off by the belt 50 are moved by rotation of the impeller 30 to a position where the pulley 51 is disposed, the outlets 32b are no longer covered by the belt 50 and are opened.

As a result, both the accelerated abrasive that was imparted with centrifugal force inside the abrasive flow channels 32, and the air in the abrasive flow channels 32 where the pressure is increased by compression due to centrifugal force, are ejected from the outlets of the abrasive flow channels due to the opening of the outlets 32b that were being blocked off by the belt 50. Both the accelerated abrasive and compressed air accordingly fly toward the workpiece 20, as illustrated by the arrows in FIG. 1 and FIG. 2.

As described above, the abrasive flow channels 32 provided in the impeller 30 of the present invention are formed such that the outlets 32b (the outer peripheral ends 35b of the blades 35) face rearward in the rotation direction of the impeller 30. The blades 35 are also disposed with a large inclination such that the inlet angle β1 and the outlet angle β2 are both 30° or greater. This enables resistance during rotation of the impeller to be decreased and acceleration of the abrasive and compression of the air to be performed with good efficiency.

In particular, when the provided blades 35 have curved profiles such that a longitudinal direction center of the blades 35 bulges forward in the rotation direction, a larger outlet angle β2 can be achieved than in cases in which the provided blades are formed with straight line profiles, even when formed with the same inlet angle β1. This has enabled efficient acceleration of the abrasive to be performed by further reducing the rotation resistance.

Moreover, in the configuration of the impeller according to the present invention, the abrasive flow channels 32 are greatly inclined with respect to the radial direction of the impeller 30 such that the abrasive flow channels 32 are longer. When in use, the outlets 32b of the abrasive flow channels 32 are rotated in a state that the abrasive flow channels 32 except for a part thereof are blocked off by the belt 50. This means that the air inside the abrasive flow channels 32 is imparted with centrifugal force as the impeller 30 rotates. This air is not only compressed by centrifugal force, but is also efficiently compressed due to the decreasing volume on moving along the convex faces of the blades 35 in the direction illustrated by the dashed arrow in FIG. 3 toward an edge e formed at points of intersection between the belt 50 and the outer peripheral ends 35b of the blades 35.

In particular, the abrasive flow channels 32 are longer and the edge e is at a more acute angle in configurations in which the blades 35 are formed with curved profiles. This enables the air inside the abrasive flow channels 32 to be compressed to a higher pressure than cases in which the abrasive flow channels are formed with shorter, straight line profiles.

Moreover, as illustrated in FIG. 4, in the impeller 30 of the present invention, the abrasive flow channels 32 are formed in a tapered shape, having a width in the thickness direction of the impeller 30 that gradually becomes narrower from the inlet 32a side toward the outlet 32b side.

Such a configuration adjusts the flow channel sectional area of the abrasive flow channels 32 so as not to become excessively large on progression from the inlet 32a side toward the outlet 32b side, or, so as to maintain a constant flow channel sectional area, or so as to decrease the flow channel sectional area on progression toward the outlets 32b.

As a result, a decrease in the flow speed of the airflow flowing inside the abrasive flow channels from the inlet side toward the outlet side which arises when the flow channel sectional area becoming excessively large, is suppressed from occurring, or the flow speed is raised in cases in which the flow channel sectional area decreases.

This means that in the impeller 30 of the present invention, compressed air at higher pressure and higher speed can be ejected from the outlets of the abrasive flow channels 32, so as to enable the ejection speed to be raised of the abrasive being shot out while being carried on the airflow.

The abrasive ejected while being carried on the high speed airflow is thereby either directly ejected onto the workpiece 20, or guided by the guide plate 70 illustrated in FIG. 1 and FIG. 2 and ejected onto the workpiece 20, so as to cut and polish the workpiece 20.

The impeller 30 of the present invention is configured such that abrasive is not only accelerated by the centrifugal force due to rotation of the impeller 30 as described above, but the abrasive is also be ejected out while being carried on the high speed airflow. This configuration means that even in cases in which abrasive is guided by the guide plate 70 as illustrated in FIG. 1 and FIG. 2, the direction of flight of the abrasive is easily controlled, and a reduction in speed thereof is not liable to occur.

As a result, the workpiece 20 can be bombarded with the abrasive maintaining a high ejection speed by the blasting apparatus 1 of the present invention, even without taking measures to prevent a reduction in speed of the abrasive such as providing air nozzles (not illustrated in the drawings) disposed parallel to the guide plate 70, as previously described for the configuration of the guide plate 70.

The abrasive employed for polishing the workpiece 20 in this manner falls to the bottom of the processing chamber 11 of the cabinet 10 where it accumulates. In the configuration of FIG. 1, the abrasive that has accumulated at the bottom of the processing chamber 11 is sucked into the abrasive tank 41 by the exhaust fan 62, and transported from the bottom of the processing chamber 11 into the abrasive tank 41 through the duct 61. In the configuration illustrated in FIG. 2, the abrasive is transported from the bottom of the processing chamber 11 to the inlet of the chute 42 using the bucket conveyor 63. The abrasive is accordingly re-introduced into the abrasive entry port 31 of the rotating impeller 30 through the chute 42, and ejected again.

In this manner, in the blasting apparatus 1 of the present invention, by adopting the novel-structured impeller 30 that is clearly distinct from existing impellers, not only can the ejection speed of the abrasive be raised, but air inside the abrasive flow channels 32 is also efficiently compressed, enabling the flow speed of the air discharged together with the abrasive to be raised.

Adopting the structure of the impeller 30 of the present invention therefore enables the abrasive to be ejected at an equivalent or greater ejection speed to that of a conventional impeller even in cases in which the diameter and/or the rotation speed of the impeller 30 has been decreased. This enables the device to be made more compact and lighter in weight, enabling the power consumption of the motor rotating the impeller 30 to be reduced.

Note that as described above, the abrasive inside the abrasive flow channels 32 moves along the inner walls (convex faces of the blades 35) disposed at the rear in the rotation direction from out of the inner walls of the abrasive flow channels 32, with a relative speed from the inner peripheral side to the outer peripheral side of the impeller 30. This means that the inner walls (convex faces of the blades 35) of the abrasive flow channels 32 disposed at the rear in the rotation direction incur significantly greater wear from contact with the abrasive than other portions.

However, adopting the configuration in which the wear resistant protection members 36 are detachably mounted to these portions means that even when wear has occurred due to contact with the abrasive, the impeller 30 can be easily refurbished by replacing the protection members 36 alone.

### DESCRIPTION OF REFERENCE NUMERALS

1. Blasting apparatus
10. Cabinet
11. Processing chamber
14. Hopper
20. Workpiece
30. Impeller
31. Abrasive entry port
32. Abrasive flow channels
32a. Inlet
32b. Outlet
33. Body
34. Opposing plate
35. Blade
35a. Inner peripheral end (of the blade 35)
35b. Outer peripheral end (of the blade 35)
35′. Auxiliary blade
36. Wear resistant protection member
37. Recesses
40. Abrasive feed unit
41. Abrasive tank
42. Chute
50. Covering unit
51, 52, 53, 54. Pulleys
60. Abrasive transport unit
61. Duct
62. Exhaust fan
63. Bucket conveyor
63a. Chain belt
63b. Bucket
70. Guide plate
130, 230. Impeller
131, 231. Abrasive entry port
132, 232. Abrasive flow channel
132a, 232a. Inlet
132b, 232b. Outlet
133. Body
134. Opposing plate
135. Blade
135a. Inner peripheral end (of the blade 135)
135b. Outer peripheral end (of the blade 135)
150. Belt
150′. Casing

1. An impeller for use in a blasting apparatus, wherein:
the impeller has an external shape of a circular disk shape with a predetermined thickness, and includes an abrasive entry port, and a plurality of abrasive flow channels formed at predetermined spacings around the circumferential direction within the thickness of the impeller, each of the abrasive flow channels having an inlet communicated with the abrasive entry port and an outlet opening onto an outer peripheral face of the impeller;
the abrasive flow channels are provided so as to be inclined with respect to a radial direction of the impeller such that ends on the outlet side of the abrasive flow channels face to a rearward side in a rotation direction of the impeller; and
an intersection angle between ends at the inlet side of inner walls at the rearward side in the rotation direction of the abrasive flow channels and a radius of the impeller, and an intersection angle between ends at the outlet side of the inner walls at the rearward side in the rotation direction of the abrasive flow channels and the radius of the impeller, are both 30° or greater.

2. The impeller according to claim 1 further comprising:
a body formed in a circular disk shape;
an opposing plate formed in an endless ring shape, and opposed to the body, the opposing plate including the abrasive entry port; and
a plurality of blades disposed at predetermined spacings along a circumferential direction so as to span between the body and the opposing plate, each of the abrasive flow channels being formed between one of the blades and another of the blades; and each of the blades being formed with a curved profile such that a center portion in a longitudinal direction of each of the blades bulges forward in the rotation direction.

3. The impeller according to claim 1, wherein the abrasive flow channels are formed with a profile in which a width of the abrasive flow channels in the thickness direction of the impeller gradually narrows from the inlet side toward the outlet side.

4. The impeller according to claim 1, wherein a wear resistant protection member is attached to an inner wall at the rearward side in the rotation direction of the abrasive flow channels.

5. A blasting apparatus comprising:
the impeller according to claim 1 as an abrasive accelerator unit;
a drive source to rotate the impeller;
an abrasive feed unit to feed the abrasive into the abrasive entry port of the impeller; and
a covering unit covering an outer periphery of the impeller except for a portion thereof.

6. A method of manufacturing an impeller for use in a blasting apparatus, the method employing a 3D printer to manufacture the impeller according to claim 1 by additive manufacturing.

7. The impeller according to claim 2, wherein the abrasive flow channels are formed with a profile in which a width of the abrasive flow channels in the thickness direction of the impeller gradually narrows from the inlet side toward the outlet side.

8. The impeller according to claim 2, wherein a wear resistant protection member is attached to an inner wall at the rearward side in the rotation direction of the abrasive flow channels.

9. The impeller according to claim 3, wherein a wear resistant protection member is attached to an inner wall at the rearward side in the rotation direction of the abrasive flow channels.

10. The impeller according to claim 7, wherein a wear resistant protection member is attached to an inner wall at the rearward side in the rotation direction of the abrasive flow channels.

11. A blasting apparatus comprising:
the impeller according to claim 2 as an abrasive accelerator unit;
a drive source to rotate the impeller;
an abrasive feed unit to feed the abrasive into the abrasive entry port of the impeller; and
a covering unit covering an outer periphery of the impeller except for a portion thereof.

12. A blasting apparatus comprising:
the impeller according to claim 3 as an abrasive accelerator unit;
a drive source to rotate the impeller;
an abrasive feed unit to feed the abrasive into the abrasive entry port of the impeller; and
a covering unit covering an outer periphery of the impeller except for a portion thereof.

13. A blasting apparatus comprising:
the impeller according to claim 4 as an abrasive accelerator unit;
a drive source to rotate the impeller;
an abrasive feed unit to feed the abrasive into the abrasive entry port of the impeller; and
a covering unit covering an outer periphery of the impeller except for a portion thereof.

14. A blasting apparatus comprising:
the impeller according to claim 7 as an abrasive accelerator unit;
a drive source to rotate the impeller;
an abrasive feed unit to feed the abrasive into the abrasive entry port of the impeller; and
a covering unit covering an outer periphery of the impeller except for a portion thereof.

15. A blasting apparatus comprising:
the impeller according to claim 8 as an abrasive accelerator unit;
a drive source to rotate the impeller;
an abrasive feed unit to feed the abrasive into the abrasive entry port of the impeller; and
a covering unit covering an outer periphery of the impeller except for a portion thereof.

16. A blasting apparatus comprising:
the impeller according to claim 9 as an abrasive accelerator unit;
a drive source to rotate the impeller;
an abrasive feed unit to feed the abrasive into the abrasive entry port of the impeller; and
a covering unit covering an outer periphery of the impeller except for a portion thereof.

17. A blasting apparatus comprising:
the impeller according to claim 10 as an abrasive accelerator unit;
a drive source to rotate the impeller;
an abrasive feed unit to feed the abrasive into the abrasive entry port of the impeller; and
a covering unit covering an outer periphery of the impeller except for a portion thereof.

18. A method of manufacturing an impeller for use in a blasting apparatus, the method employing a 3D printer to manufacture the impeller according to claim 2 by additive manufacturing.

19. A method of manufacturing an impeller for use in a blasting apparatus, the method employing a 3D printer to manufacture the impeller according to claim 3 by additive manufacturing.

20. A method of manufacturing an impeller for use in a blasting apparatus, the method employing a 3D printer to manufacture the impeller according to claim 2 by additive manufacturing.
